(19) United States
(12) Patent Application Publication
(10) Pub. No.: US 2023/0379635 A1
(43) Pub. Date: Nov. 23, 2023

(54) MEMS MICROPHONE

(71) Applicant: AAC Kaitai Technologies (Wuhan) CO., LTD, Wuhan (CN)

(72) Inventors: Zhuanzhuan Zhao, Shenzhen (CN); Kaijie Wang, Shenzhen (CN); Rui Zhang, Shenzhen (CN)

(21) Appl. No.: 17/879,815

(22) Filed: Aug. 3, 2022

(30) Foreign Application Priority Data
May 18, 2022 (CN) 202221236854.6

(51) Int. Cl. H04R 19/04; H04R 7/04

(52) U.S. Cl. CPC H04R 19/04; H04R 7/04; H04R 2201/003

(57) ABSTRACT

Provided is a MEMS microphone, including a base which forms a back cavity, and a capacitor system arranged on the base and connected to the base. The capacitor system includes a diaphragm located above the base and a backplate spaced from the diaphragm; and the MEMS microphone further includes a barrier structure, and the barrier structure is spaced from the capacitor system in a vibration direction. The barrier structure spaced from the capacitor system in the vibration direction can ensure that the movement of the diaphragm and the backplate is not affected under low sound pressure, so as not to affect the performance of the microphone, and can hinder the deformation of the diaphragm and the backplate under large sound pressure, thereby inhibiting failure of the microphone caused by fracture due to large deformation of the diaphragm and the backplate.

### TECHNICAL FIELD

The present invention belongs to the field of electroacoustics, and in particular, to a Micro-Electro-Mechanical System (MEMS) microphone with high reliability.

### BACKGROUND

An existing capacitive MEMS microphone chip is mainly composed of a capacitor part and a base part. The chip mainly includes a base structure having a back cavity, and a diaphragm and a fixed backplate structure that are located above the base. The diaphragm and the fixed backplate form a capacitor system, as shown in FIG. 1. When a sound pressure is applied to the diaphragm, a pressure difference exists between two surfaces of the diaphragm facing the backplate or facing away from the backplate, such that the diaphragm moves close to the backplate or away from the backplate, thereby causing a change in capacitance between the diaphragm and the backplate to realize conversion from sound signals to electrical signals. This is an operating principle of the capacitive MEMS microphone.

When the sound pressure is high, the diaphragm and the backplate are attached together and continue to deform. When the sound pressure is high enough, the diaphragm and the backplate deform excessively, and the diaphragm and the backplate break at a certain position, resulting in failure of the microphone.

Therefore, there is a need to provide a new MEMS microphone with high reliability.

### SUMMARY

Based on the above problems, the present invention provides a new MEMS microphone chip structure with high reliability. Specifically, the technical solution of the present invention is as follows.

Provided is an MEMS microphone, including a base which forms a back cavity, and a capacitor system arranged on the base and connected to the base. The capacitor system includes a diaphragm located above the base and a backplate spaced from the diaphragm; and the MEMS microphone further includes a barrier structure, and the barrier structure is spaced from the capacitor system in a vibration direction.

In an improved embodiment, the barrier structure is arranged on a surface of the backplate facing away from the diaphragm in the capacitor system.

In an improved embodiment, the barrier structure includes an outer frame portion, and a plurality of beam portions connected to the outer frame portion and extending inward.

In an improved embodiment, the barrier structure is of a cross structure formed by four beam portions extending inward.

In an improved embodiment, a projection of an outer edge of the outer frame portion of the barrier structure in the vibration direction overlaps with a projection of an outer edge of the capacitor system in the vibration direction.

In an improved embodiment, a washer is further provided between the outer frame portion of the barrier structure and the capacitor system, and the washer completely overlaps with the outer frame portion.

In an improved embodiment, the barrier structure is further provided with a reinforcing portion at a center position of the barrier structure.

In an improved embodiment, the barrier structure is arranged along the vibration direction at a surface of the diaphragm facing away from the backplate in the capacitor system, and the barrier structure is spaced from the diaphragm.

The present invention has the following beneficial effects.

Compared with the prior art, in the MEMS microphone according to the present invention, the barrier structure spaced from the capacitor system in the vibration direction can ensure that the movement of the diaphragm and the backplate is not affected under low sound pressure, so as not to affect the performance of the microphone, and can hinder the deformation of the diaphragm and the backplate under large sound pressure, thereby inhibiting failure of the microphone caused by fracture due to large deformation of the diaphragm and the backplate.

### BRIEF DESCRIPTION OF DRAWINGS

FIG. 1 is a schematic three-dimensional view of an MEMS microphone in the prior art;

FIG. 2 is a schematic sectional view of the MEMS microphone shown in FIG. 1 taken along a line A-A;

FIG. 3 is a schematic three-dimensional view of an MEMS microphone according to Embodiment 1 of the present invention

FIG. 4 is a schematic sectional view of the MEMS microphone shown in FIG. 3 taken along a line B-B;

FIG. 5 is an enlarged view of a portion C shown in FIG. 4;

FIG. 6 is a schematic diagram of a barrier structure according to Embodiment 1 of the present invention; and

FIG. 7 is a schematic diagram of a barrier structure according to Embodiment 2 of the present invention.

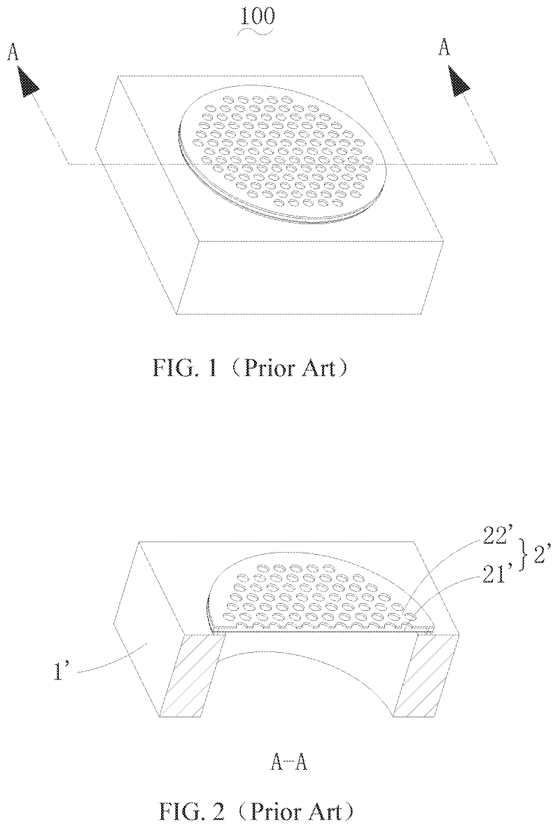

### DESCRIPTION OF EMBODIMENTS

To enable the above objectives, features and advantages of the present invention to be more understandable, a detailed description of the present invention is given with reference to specific embodiments to make the above and other objectives, features and advantages of the present invention clearer.

It should be made clear that the embodiments described are merely some rather than all of the embodiments of the present invention. All other embodiments acquired by those of ordinary skill in the art without creative efforts based on the embodiments in the present invention shall fall within a scope of the present invention.

### Embodiment 1

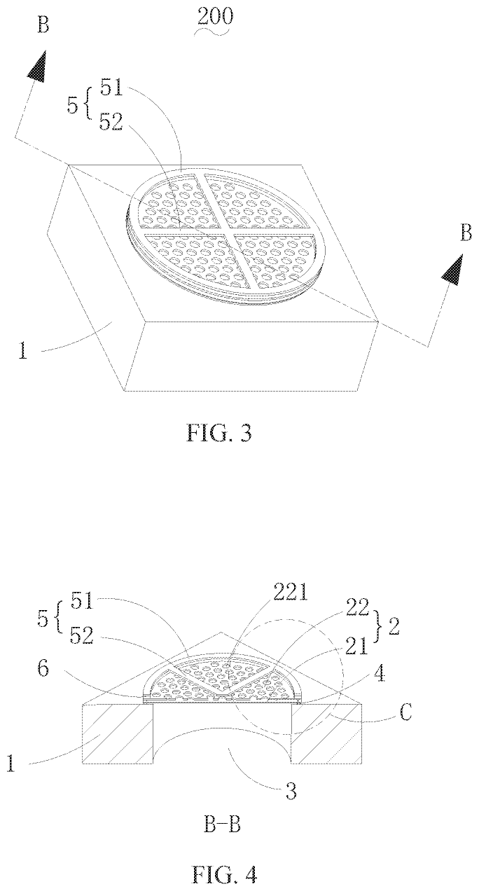

Referring to FIG. 3 to FIG. 4, an MEMS microphone 200 mainly includes a base 1 and a capacitor system 2. The base 1, which is for example a silicon base, forms a back cavity 3 by etching. The capacitor system 2 is arranged on an upper surface of the base 1 and in insulated connection with the base 1 via a transition layer 4. The capacitor system 2 includes a diaphragm 21 and a backplate 22 spaced from the diaphragm 21. Generally, the backplate 22 is further provided with a through hole 221, which facilitates transmission of sound.

Specifically, in this embodiment, a barrier structure 5 is provided and spaced from the capacitor system 2 in a vibration direction. Specifically, the barrier structure 5 is arranged on a surface of the backplate 22 facing away from the diaphragm 21. In practical applications, movement of the diaphragm 21 and the backplate 22 is not affected under low sound pressure, so that the performance of the microphone is not affected; and deformation of the diaphragm 21 and the backplate 22 can be hindered under large sound pressure, thereby inhibiting failure of the microphone caused by fracture due to large deformation of the diaphragm 21 and the backplate 22.

Further, the barrier structure 5 includes an outer frame portion 51 and a plurality of beam portions 52 connected to the outer frame portion 51 and extending inward, so as to effectively hinder the deformation of the diaphragm 21 and the backplate 22.

Further, referring to FIG. 6, the barrier structure 5 is of a cross structure formed by four beam portions 52 extending inward. In other embodiments, the number of the beam portions 52 may also be 5, 6, 7, or the like. The shape of the barrier structure 5 is not limited to that shown in the embodiments of the present invention.

As one improvement, in order to reduce a size of the barrier structure 5 and keeps the MEMS Microphone 200 miniaturized, a projection of an edge of the outer frame portion 51 of the barrier structure 5 in the vibration direction overlaps with a projection of an outer edge of the capacitor system 2 in the vibration direction.

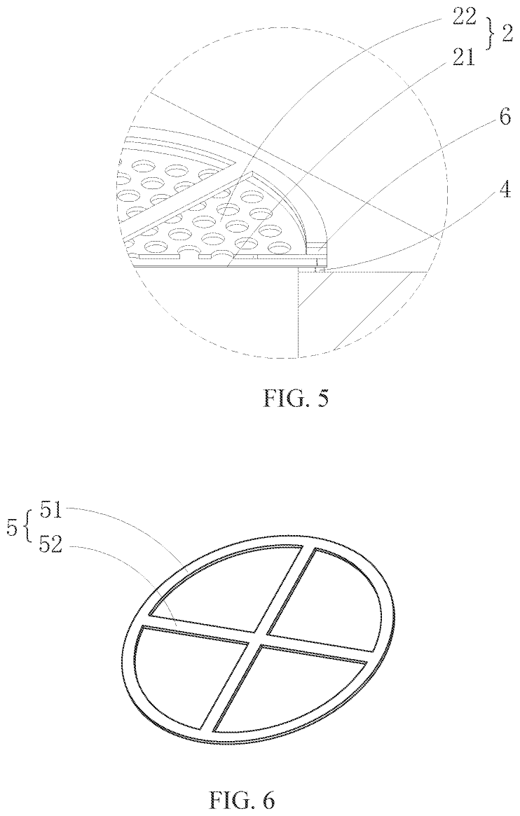

As one improvement, referring to FIG. 5, a washer 6 is further provided between the outer frame portion 51 of the barrier structure 5 and the backplate 22. There is a certain distance between the barrier structure 5 and the backplate 22, so that the movement of the diaphragm 21 and backplate 22 may not be affected under small sound pressure, so as not to affect the performance of the microphone. The deformation of the diaphragm 21 and the backplate 22 can be hindered under large sound pressure, thereby inhibiting failure of the microphone caused by fracture due to large deformation of the diaphragm 21 and the backplate 22.

In other embodiments, the barrier structure 5 may be arranged at a surface of the diaphragm 21 facing away from the backplate 22, and the barrier structure 5 may be spaced from the diaphragm 21. Large deformation of the diaphragm 21 and the backplate 22 is inhibited.

### Embodiment 2

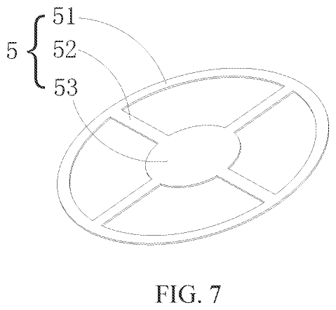

Referring to FIG. 7, Embodiment 2 has basically the same structure as the MEMS microphone 200 of Embodiment 1, and a difference is that the barrier structure 5 is further provided with a reinforcing portion 53 at a center position of the barrier structure 5. The reinforcing portion 53 may be in different shapes, such as a circle, a rectangle, or a triangle. The reinforcing portion 53 strengthens the hindrance to the deformation of the diaphragm 21 and the backplate 22, so as to inhibit the deformation.

In addition, in the MEMS microphone described in the present invention, the shape of the barrier structure is not limited to that shown in the embodiments of the present invention.

In the MEMS microphone according to the present invention, the barrier structure spaced from the capacitor system in the vibration direction can ensure that the movement of the diaphragm and the backplate is not affected under low sound pressure, so as not to affect the performance of the microphone, and can hinder the deformation of the diaphragm and the backplate under large sound pressure, thereby inhibiting failure of the microphone caused by fracture due to large deformation of the diaphragm and the backplate.

The above description merely illustrates some embodiments of the present invention. It should be noted that, for those of ordinary skill in the art, improvements can also be made without departing from a creative concept of the present invention, all of which shall fall within a scope of the present invention.

What is claimed is:

1. An MEMS microphone, comprising a base which forms a back cavity, and a capacitor system arranged on the base and connected to the base, wherein the capacitor system comprises a diaphragm located above the base and a backplate spaced from the diaphragm; and the MEMS microphone further comprises a barrier structure, and the barrier structure is spaced from the capacitor system in a vibration direction.

2. The MEMS microphone as described in claim 1, wherein the barrier structure is arranged on a surface of the backplate facing away from the diaphragm in the capacitor system.

3. The MEMS microphone as described in claim 1, wherein the barrier structure comprises an outer frame portion, and a plurality of beam portions connected to the outer frame portion and extending inward.

4. The MEMS microphone as described in claim 3, wherein the barrier structure is of a cross structure formed by four beam portions extending inward.

5. The MEMS microphone as described in claim 3, wherein a projection of an outer edge of the outer frame portion of the barrier structure in the vibration direction overlaps with a projection of an outer edge of the capacitor system in the vibration direction.

6. The MEMS microphone as described in claim 3, wherein a washer is further provided between the outer frame portion of the barrier structure and the capacitor system, and the washer completely overlaps with the outer frame portion.

7. The MEMS microphone as described in claim 3, wherein the barrier structure is further provided with a reinforcing portion at a center position of the barrier structure.

8. The MEMS microphone as described in claim 1, wherein the barrier structure is arranged along the vibration direction at a surface of the diaphragm facing away from the backplate in the capacitor system, and the barrier structure is spaced from the diaphragm.
